(19) United States
(12) Patent Application Publication
(10) Pub. No.: US 2006/0075391 A1
(43) Pub. Date: Apr. 6, 2006

(54) Distributed scenario generation

(76) Inventors: Laurence G. Esmonde JR., West Chester, PA (US); Michael J. Horton, Ambler, PA (US); Bryan K. Hunter, Collegeville, PA (US); Mark C. Kilby, Altamonte Springs, FL (US); John R. Neyer JR., Harleysville, PA (US); David F.C. Perme, Wayne, PA (US); Robert H. Pollack, Philadelphia, PA (US); James J. Solderitsch, Rosemont, PA (US); Peter J. Solderitsch, Havertown, PA (US); Bryan S. Tedesco, Downington, PA (US)

Correspondence Address: RUSSELL O. PAIGE, 51 LOUISIANA AVENUE, N.W., WASHINGTON, DC, 20001-2113, US

(21) Appl. No.: 10/958,561

(22) Filed: Oct. 5, 2004

(51) Int. Cl. G06F 9/45

(52) U.S. Cl. 717/136

(57) ABSTRACT

A Scenario Generation Framework is described. The Framework provides the organizational infrastructure through which scenario data—a shared set of data supporting enterprise application coordination and interoperation—can effectively be managed from a centralized location. From this location, the framework provides capabilities whereby scenario data, described using a published data representation format, can be copied, viewed, formally compared, modified and combined with other segments of scenario data. Also from this location, suitably transformed data can be communicated to applications for use in initializing their execution in concert with other applications. In the preferred embodiment of the framework, workflow management capabilities are included to allow distribution and control of data preparation activities and an integrated workstation is made available to facilitate data manipulation and modification.

### BACKGROUND

1. Field of the Invention

This invention relates to the general area of Enterprise Application Integration (EAI) and the ability to prepare initialization data (Scenario Data) for applications across an enterprise and to recall data from these applications to coordinate their future interactions with one another. In the case addressed by this invention, an enterprise can encompass a national or even international confederation of applications. In particular, the invention addresses how to acquire, manage and distribute data among applications in a manner designed to reduce both the time and effort needed to prepare these applications for use in a defined enterprise environment.

2. Background of the Related Art

The term Enterprise Application Integration (EAI) refers to the goal of allowing several information systems or applications that are in use within an enterprise (a company or organization) somehow to be made aware of each other. Examples of this awareness include the ability that data produced by one can be shared or communicated to another; or, that actions taken by one can consequentially lead to actions taken by another. Such awareness and interaction can be aided by actions taken by human operators of these systems or they can occur automatically by creating communication channels between the applications.

For the purpose of this document, a more restricted view of EAI will be adopted where the focus is on the initial communication of base line information of particular interest to the enterprise, in a form usable by the applications. All of the applications need to be provided with a common set of initialization data called a Scenario so that when the family of applications begins execution, the starting point of these applications is consistent with data contained within the Scenario. Once the applications begin execution, it is assumed that there already may be channels through which the applications can communicate with one another or they may execute in isolation from one another.

A specific instance where this kind of EAI is observable and where the difficulties of achieving this EAI are readily apparent occurs within military training and simulation centers. The task of these centers is to train war fighters in the use of expensive equipment such as military aircraft and in the development of tactics to coordinate the use of this equipment to achieve specific mission objectives. The centers conduct training exercises, often distributed across multiple physical locations, where multiple personnel are interacting with multiple simulation systems (e.g. cockpit simulators, air battle plan generators, command and control systems) and occasionally with deployed personnel operating real equipment in the field.

An exercise is usually created with a specific goal in mind to achieve one or more training objectives. It is important that the various simulation systems and command and control systems involved in the exercise have a consistent view of the data needed to provide a realistic training experience. But each of these systems is typically developed in complete isolation from each other with its own internal way of organizing data and accepting initialization data.

Simulation systems have historically not been designed to operate with one another. Typically they have been designed and built to serve the needs of specific audiences and for specific purposes. For example there are cockpit simulations built to train pilots operating individual aircraft. An Air Operation Simulation (e.g. the Air Warfare Simulation—AWSIM—of the United States Air Force) trains commanders in the development of military air campaigns. There are other systems targeted at intelligence gathering and analysis and post-mission data capture and re-planning.

Modern warfare planning and training activities require that these various systems must not operate in isolation. In many cases, there already are standard ways of sharing operational data among these systems. Such military standards as the Distributed Interactive Simulation (DIS) and High Level Architecture (HLA) Run-Time Infrastructure (RTI) allow systems to emit data that they control in order to share with other systems, and to consume necessary data that is generated or controlled by other systems. For example, these standards enable one cockpit simulation display to be aware of, and display, aircraft images belonging to other participants in the training exercise. Most modern simulation systems include support for one or more of these standards.

Despite these known techniques, there currently is no standard way of seeding a particular system with data that will allow it to begin its operational behaviors from some defined starting point and in some defined state. Each system comes with its own proprietary mechanism to achieve this initialization and the typical practice at military simulation and training centers is to devote a large number of system experts, over a long period of time, to the manual task of interpreting the goals of a particular exercise, assembling data in a form that can be input to each of the systems, and finally using each system's initialization mechanisms to load the data into the system.

Often there is an additional desire first, to extract some data from a real-world system such as the Modernized Integrated Data Base (MIDB) or Air Operations Data Base (AODB) and second, to use this data, properly transformed and refined, to load into one or more of the simulation systems involved in the exercise. Once again, there are proprietary mechanisms to extract this information, manual processes to edit and prepare it for use, and finally more manual processes to load the refined data into the simulation as initialization data for a particular training exercise.

There are known technologies and methods that facilitate data sharing but these have been slow to catch on in the military world. Much of the commercial information systems world is actively exploring the use of such technology components as XML (Extensible Markup Language) for data representation and Simple Object Access Protocol (SOAP) for remote execution of distributed application components and services. Nonetheless, the problem of effectively defining Scenario data and loading this data into simulation and training system components remains. It may be a long time before some of the existing system components are replaced or upgraded to feature built-in support for these technologies and there is an immediate need to lessen the manual burden of collecting data in the proper format and loading it into the needed systems components.

One possible starting point—one employed at some existing training and simulation centers—is to create data adaptor tools that translate data from one output format (e.g. obtained from an authoritative data source like MIDB or AODB) into another input format used by a particular simulation or training system. This will lessen the manual burden for moving data between a particular pair of systems but a separate adaptor tool will be needed to support each pair of producer-to-consumer data transformations. This approach, however, does not improve efficiency by a significant margin, as new adaptors will need to be written whenever a new data source or new data consumer appears.

To address the problems inherent in point-to-point adaptor tools, a standard intermediate data representation format into which data coming from the various information sources can be converted, and from which data to be delivered to consuming applications can also be converted provides an attractive opportunity. So, instead of converting one-to-one from data producers to data consumers which potentially requires n×m adaptors when there are n distinct data sources and m distinct data consumers, this approach requires only n+m adaptors to convert to and from the standard data representation. In defining this intermediate form extensible markup language, (XML) provides a convenient starting point. XML data representation can also be further refined through the use of XML Schema Documents defined using an XML Schema Definition (XSD) specification. The schema precisely defines what format application data needs to be converted from and converted to and there are many XML tools that can be applied in the production of such data.

But having an intermediate form for data to facilitate Scenario data initialization is not sufficient. There must be a location, the Scenario Server, where data that are extracted from authoritative data sources are saved in the intermediate format for later transferal to the family of applications. A simple store-and-forward storage location is not sufficient as there also should be a capability where data in the standard intermediate form can be examined and where versions of similar data sets can be compared and if necessary edited. Since the intermediate form is XML, which is typically textual, an ordinary text editor can be used to examine instances of Scenario data but human editing of these data files can introduce errors where the edited data may no longer be compatible with the XML schema used to define the intermediate form.

Thus, in addition to a server, a Scenario data editing and manipulation toolset would enable the enterprise to manage carefully its data and guarantee that any changes made to the data do not violate the schema used to codify the data. It would be preferable if this toolset were somehow attached to the server so that if the format were to be modified, and a new version of the intermediate form were created, and this required changes to tools in the set, then modified versions of these tools could be delivered to enterprise users directly from the server. Moreover, the server and toolset need to provide the ability to query data already stored in the server by version and allow for existing data to be updated to conform to a new version.

Given that scenario data processing is an enterprise concern, faulty or inconsistent data can lead to far-reaching consequences. Thus, having server and toolset components as outlined above can potentially lead to serious management issues. Arbitrary edits to data stored in the intermediate form, even when guided by supportive tools, should not be pushed to applications without proper review and approval. Depending on the structure of the enterprise, multiple levels of approval may be required. The enterprise may also have specialists who are asked to take on editing and review tasks on subsections of the data so that there is a management need to identify these specialists, decompose data into sections for editing and review by the specialists, and then later these approved sections can be merged together for dissemination to the applications when approved by an authorized supervisor.

There is emerging technology that promises to help automate and formalize management and review processes such as those needed for Scenario generation. One promising candidate for defining these processes is Business Process Execution Language (BPEL) and its Web Services extension BPELWS. But BPEL and BPELWS technology by themselves are insufficient—the management and review technology must be integrated into the Scenario Generation environment so that the toolset, server capabilities, and management functions are all coordinated via processes specified in a language such as BPEL.

Scenario generation as discussed previously in this section is limited to a one-way transfer of information from a source (or collection of sources) to a family of applications that need to be initialized in a consistent manner. But in the simulation and training domain there is often a need to initialize the applications, execute them for a period of time, and then stop the applications with the expectation of re-starting them. When stopped, data resident within these applications will have changed based on events that have occurred and it would therefore be advantageous to use application data as source data for retrieval to the server. Of course, these data also need to be converted to the standard intermediate form supported by the server and this can be accomplished only if applications are also viewed as potential sources of persistent Scenario data. Thus, there would need to be data pull adaptors written for each of the applications whose data needed to be captured on the server.

Along with pulling data back from the applications, situations also arise where enterprise data sources (e.g. MIDB and AODB for the military enterprise) might also be modified from data held within the server so that when data is actually pulled from the source again, it includes changes based on desired initialization values for the receiving applications. In effect, the server is best designed to allow any data provider to also be viewed as a consumer and vice versa, any consumer can be treated as a provider. This requires that the data adaptors written for each data point be two-way adaptors permitting data to move from the data point to the server and back to the data point.

The use of XML provides a means to standardize a data format, but an enterprise is likely to have a multitude of information contexts and thus the data required in one context is likely to be very dissimilar from that needed in another context. So instead of a single XML schema to support the enterprise, it is more realistic to expect that multiple schemas are needed, with perhaps shared sub-schemas where the contexts overlap.

Once again the military simulation and training enterprise provides a cogent example. The basic data elements in play within a distributed simulation: equipment, including aircraft and munitions; personnel, including their organization into hierarchies of units; and locations, such as bases and ships that are collectively known as Unit Order of Battle (UOB). Any Scenario generation environment for this enterprise must support all these data. But UOB is only one information context example among many. Others include Terrain data showing ground features such as mountains, rivers and roads; Parametric data describing flight and movement characteristics of the equipment being simulated or controlled; Weather data showing the presence of clouds and storms that can affect the outcome of a military mission. Many of the application components involved in a simulation and training exercise need to be initialized with data for each of these contexts. There needs to be a standard form, preferably defined by an appropriate XML schema, for data in each context and the server needs to coordinate data flow to and from each application component for any applicable context.

Each context, relevant to scenario generation for the enterprise, would best be served by a specialized tool that supports displaying and editing data in the appropriate context. The cost to manually develop supportive tools for each context may be significant. A possible approach to reduce cost is to create a software component that can use the XML schema for each context as the basis for creating a tool with a user interface that is easy to use and which supports controlled editing. There are already known commercial XML tools that allow general XML documents to be written and edited based on a specific XML schema but these tools are generally textually oriented.

What an enterprise tool for Scenario generation needs is an interface that is appropriate for how the applications used by the enterprise view their information contexts. For example, UOB data is often concerned with where units are deployed: the location of air bases and ships on a map, and with the equipment available to units deployed at various locations. A Scenario editing tool for this context needs a user interface that includes a geographic map component to show where things are, and preferably a means to use the map to edit locations of units. To support the map view, a tabular view showing all of the units in the UOB data set is also desirable. A pop-up viewer to show the available equipment and permit any number of each to be changed easily is needed when focusing on a unit with equipment. But for parametric data (e.g. for flight characteristics of a particular aircraft), a simple table oriented interface is sufficient, where each characteristic can be edited textually or via pop-up list elements. The complete list of aircraft with definable parametrics could be presented as a table or perhaps a tree with categories of aircraft available as nodes in the tree.

Thus, current practices of Scenario Generation for Enterprise Application Integration include the following shortcomings:
a) Gathering and preparing data for initialization of applications in an enterprise is largely done manually.
b) Where there is automation support, it is often in the form of custom data adaptors allowing data from a single data source to be transformed for use by a single application component.
c) XML technologies remain under-utilized, especially in military enterprises such as training and simulation centers.
d) Simply adopting a common XML intermediate form addresses the inefficiency of pair-wise adaptors but adds a management and maintenance task to the enterprise.
e) Within a large-scale enterprise, a single XML intermediate form is not sufficient; there are likely multiple information contexts, each of which is best served by its own intermediate form.
f) Using a server to help with management and maintenance does not help with controlled editing of data represented in the intermediate form.
g) A supportive toolset in conjunction with a server can help provide data quality and consistency but this does not help the enterprise control the processes by which data is distributed within the enterprise and by which management reviews and approves or rejects work done on those data.
h) BPEL provides a possible approach for defining and managing scenario data creation, modification and review but there is no current system to automate scenario data preparation in a coordinated environment.
i) Scenario generation is typically viewed as a one-way operation where data comes from various external sources and is pushed out to applications within the enterprise instead of a two-way view where application data can be pushed back to the server (and from the server back out to the external data sources), which can lead to more complete enterprise information management.
j) XML tools currently available that allow schema based editing of documents are typically textually oriented; within an enterprise scenario generation environment customized tools that display and manipulate data in a form tailored to the enterprise's view and use of the data is desirable.

### OBJECTS AND ADVANTAGES

To overcome the limitations and disadvantages of the prior art, it is the object of the present invention to provide the following features and advantages:
a) to provide an extensible Scenario Generation Server Data Interchange Format (SGSDIF) specified with an XML schema to use as the specification of a basic intermediate form suitable for the representation of Scenario data,
b) to provide a Scenario Generation Server (SGS) architecture and implementation with the following features:
   i) a scenario data storage repository
   ii) computer network access to enterprise information producers and consumers between which scenario data can be exchanged and from which scenario data can be obtained for storage in the repository
   iii) the ability to treat data producers as consumers of scenario data and data consumers as producers of scenario data
   iv) direct access to all Scenario Generation toolset components compatible with the latest SGSDIF so that new components can be made available as needed to enterprise users
   v) an enterprise scenario data user management capability to define collections of users and their roles and responsibilities with regard to scenario data management
   vi) an Application Program Interface (API) and related adaptor development documentation to allow adaptors for data exchange between the server and new information sources to be easily and efficiently developed
c) to provide a Scenario Generation toolkit architecture and implementation with the following features:
   i) SGSDIF editing tools to support the editing of individual scenario data elements
   ii) SGSDIF editing tools to support the specification of translation actions to be applied to an original scenario data set resulting in the production of a new modified data set
   iii) SGSDIF comparison tools to compare two or more existing scenario data sets and permit user selection of which elements should be retained when data sets are merged together
d) to provide a Scenario Generation workflow specification and process management capability that will coordinate use of the server and toolkit and the resulting transformation of scenario data and the delivery/receipt of this data to and from enterprise information sources
e) to support the extension of a basic scenario generation framework, including server, toolkit and data representation specification, to handle new or modified information contexts important to the enterprise
f) to support the modification of enterprise applications and systems so that specific collections of their run-time data can be captured and exported to the SGS to be used as the basis for application re-starting in a coordinated fashion with other enterprise applications

### BRIEF SUMMARY OF THE INVENTION

The system and methods of the present invention comprise a framework that includes: (a) a coordinated data representation format; (b) a server data storage system; (c) a data editing, comparison and translation toolkit; and (d) a workflow management capability to enable rapid creation and distribution of application initialization data for an enterprise wide collection of applications. Through the system and methods of the present invention it will be possible to collect data from authoritative data sources such as command and control systems as well as previously created initialization data from applications; and coordinate, filter and combine this data to address new enterprise system integration and usage goals; and communicate this data to specific applications within the enterprise. In addition, applications extended to support this invention can provide snapshots of their then current data for storage within the server storage system and subsequent use for other application initialization efforts. By relying on published XML schemas as a basis for data representation, the components of this invention allow for easy integration with new applications. By including a coordinated workflow management system, the invention enables enterprise control over how data may be edited, distributed and used within the enterprise.

### BRIEF DESCRIPTION OF THE DRAWINGS

FIG. 1 shows a software architecture diagram of the Scenario Generation System and key initial components and relationships.

FIG. 2 shows an example fragment of a SGSDIF schema specification.

FIG. 3 shows an example fragment of a SGSDIF data set conforming to a SGSDIF schema.

FIG. 4 shows an example Scenario Generation Server login window.

FIG. 5 shows an example Scenario Generation Server main functions window.

FIG. 6 shows an example Scenario Generation Server main functions window for an administrator user.

FIG. 7 shows an embodiment of the Scenario Generation Editor Graphical User Interface displaying a coordinated Map and Property Display Window.

FIG. 8 shows an embodiment of the Scenario Generation Editor Graphical User Interface displaying an entity table summary window.

FIG. 9 shows an embodiment of the Scenario Generation Translation Editor User Interface.

FIG. 10 shows an embodiment of a tabular display of the differences between two Scenario data sets.

FIG. 11 shows a chart representating scenario generation process fragment suitable for formal definition and enactment.

FIG. 12 shows a workflow diagram depicting how scenario data can be stored, extracted, merged and delivered to Applications.

FIG. 13 shows a sequence diagram that summarizes the creation of a new Scenario.

FIG. 14 shows the interaction of multiple, simultaneous Scenario Generation users both on and off a common LAN.

### DETAILED DESCRIPTION

The system and methods of the present invention provide a framework and extensible environment that will enable any enterprise that needs to create and manage Scenario data to do so efficiently and with much greater control than is possible using ad hoc and manual methods that are typical within many enterprises. The inspiration for the present invention comes from the military simulation and training enterprise where training exercises require the coordinated initialization of multiple simulation systems with data extracted and edited from multiple command and control systems.

Many of the examples and description of the operation of the present invention will be taken from this military-based enterprise. However, any enterprise that requires similar data extraction, management and adaptation of data sources for use by multiple applications within the enterprise would find the application of the present invention of great benefit both in decreasing the time and personnel needed to prepare data as well as ensuring improved data integrity and accessibility. The present invention is not merely addressing the problem of inter-application communication while enterprise applications are executing. In many enterprises, there are sufficient means and resources already available by which applications can share data while executing. But, there is a significant lack of technology to support the problem of preparing such applications prior to their initiation.

The present invention is targeted at assisting the enterprise in managing its information sources and data so that applications that need adapted forms of these data can receive them. Moreover, the present invention implements the strategy that applications that need to be initialized with data can in turn be viewed as information sources themselves.

The system and methods of the present invention include the following major components, interactions and capabilities:
Components:
   Scenario Generation Server Data Interchange Format (SGSDIF)
   Scenario Generation Server (SGS)
   Scenario Generation Metadata Catalog
   Information Source Data Adaptors
   Application Data Adaptors
   Scenario Generation Workstation (SGW)
   SGSDIF Data Translation/Mapping Engine
   SGSDIF Data Difference and Merge Engine
   Scenario Generation User Manager
   Scenario Generation Workflow Engine
Component and User Interactions:
   Add Data to Server (from information source/user)
   Extract data from Server (to application/user)
   Deliver Workstation Software to User
   Load Data into Workstation
   Modify Data using Workstation—micro editing
   Save Data from Workstation Data
   Translate/Map Scenario Data—macro editing
   Compare and Merge Scenario Data—macro editing
   Authenticate Users
   Manage Users
   Define Workflow Processes
   Enact Workflow Processes
   Monitor Workflow Processes
Capabilities:
   Import/Export Services
      From Information Source
      To Application
      From Application
      To Information Source
   Mapping/Translation Services
      From Server to Server
      From Server to Application
   Data Verification Services
      Specific to Information Context
   Messaging Services
      Support Process Monitoring
      Support Workflow
   Multiple Data Exchange Protocols
      Flat File (XML and CSV)
      JDBC
      JMS
      FTP
      HTTP
      SOAP
   User Interface Adaptation to User/Role
      Enterprise Administrator
      Event Coordinator
      Scenario Editor
   Support for Multiple Enterprise Information Contexts
      Extend SGSDIF
      Define New Information Context Data Interchange Formats
      Produce Specialized Context-Specific Workstation Features

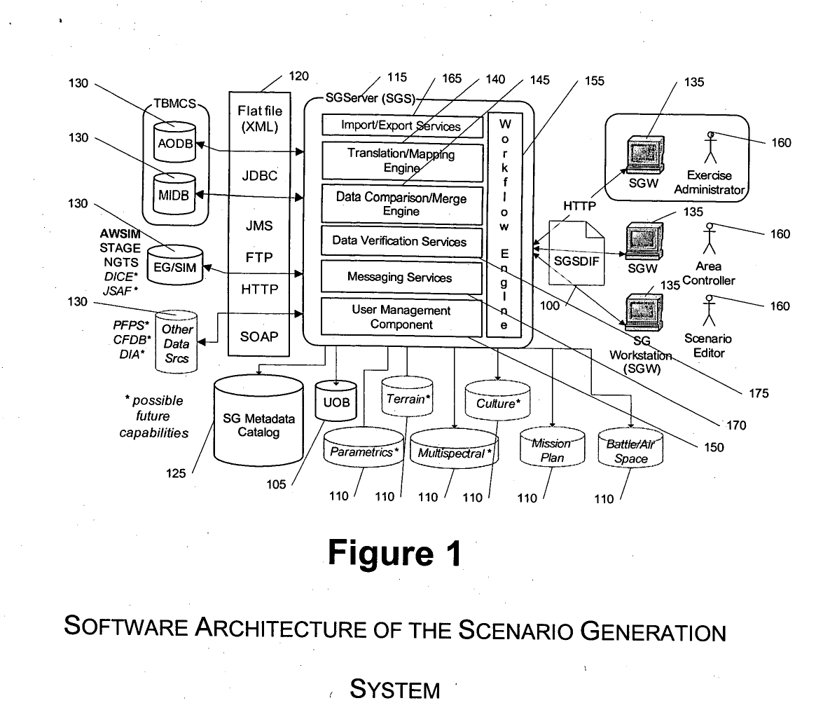

The system and methods of the present invention will be more fully understood by the following detailed description of the function of each component to support the named interactions and capabilities in an embodiment of the present invention. FIG. 1 shows many of these components and capabilities and their relationships to a human user of an embodiment of the invention and to each other. Some of the details in the figure are taken from the military training and simulation enterprise including names of information sources and information contexts.

Components

The Scenario Generation Server Data Interchange Format (SGSDIF) 100 is a specification defined by an XML schema that defines how enterprise data must be structured in order for the components and capabilities of the present invention to process this data successfully. In accordance with the principles and practices of the present invention, the structure of this specification is specific to the needs of the enterprise and the applications that need to be initialized with this data. For example in the military training and simulation domain, Unit Order of Battle (UOB) 105 data is of major importance and so the contents of SGSDIF for this enterprise would be defined to identify elements such as units, their geographical location, how much and what type of equipment is available to the unit, and other relevant or desirable elements Other information contexts 110 can be captured by extending the basic SGSDIF or by defining a new DIF for that context. By basing SGSDIF on XML, a large collection of existing software tools can be applied in creating support for XML in an embodiment of the present invention.

Data that conforms to the SGSDIF specification are communicated to the Scenario Generation Server (SGS) 115. The SGS is a core component used to provide access to existing Scenario data sets and to provide access to many Scenario Generation services. In the preferred embodiment of the invention, the SGS is implemented on the internet (or private enterprise network) as an application server to which users and applications can connect using typical network protocols 120 such as HTTP, FTP and SOAP. The SGS includes a user interface by which services provided by the server can be selected and executed by a human user. In addition, the SGS includes an application interface that allows local and remote applications also to connect to the server and execute services. In the preferred embodiment, most external applications including the various data adaptors use SOAP to connect to and exchange data with the SGS.

The Scenario Generation Metadata Catalog 125 includes descriptions of all data needed by the server to support Scenario generation. These data will include the XML schema definitions for all of the included data interchange formats including the basic SGSDIF. Since these schemas will undergo change over time, the catalog supports multiple versions of these schemas. Actual Scenario data obtained from an information source are available in the catalog and because these data are editable, versioning of these data must be supported in the catalog.

The catalog includes data to support user management functions of the server. To the extent that processes are defined in their own formal language (such as BPEL), the catalog also contains definitions of these processes. The catalog further contains connection parameters to support interaction with the various adaptors supported by the server, along with specialized information for each data source needed to complete the exchange of information from data source or application user and the server. The catalog defines and makes available specialized data to support the invocation of the various Scenario Generation services. Examples of these data are definitions of translation or mapping data to permit one SGSDIF data set to be transformed into another.

The main function of the Scenario Generation framework is to provide a means to deliver information from various providers within (or even outside) the enterprise to various applications within the enterprise that need to be initialized coherently based on the information. Data Adaptors 130 are the means by which these data flow into and out of the server. In the preferred embodiment of this invention, these adaptors use standard internet protocols 120 such as SOAP and HTTP to communicate with the server. In bringing the services of the Scenario Generation framework to the enterprise, it may be necessary to write custom adaptors to access proprietary data locations (such as databases) and formats supported by the information sources. The framework includes documentation about issues and methods for completing these custom adaptors. As the enterprise information environment matures, it is expected that newly developed information sources and enterprise applications will include standard ways to export and import data using SGSDIF so that integration with the framework and server becomes routine.

Even though the listing of components in FIG. 1 includes separate items for source data adaptors and application data adaptors, a hallmark of the present invention is that information flow from the server and its repository to the enterprise is fundamentally two-way. Application data can be re-captured as Scenario data and saved within the server. Information sources include the ability to receive data from the server so that refreshed data can be communicated back to the server for subsequent use in application data generation.

In addition to a server component, the system and methods of the present invention include an integrated Scenario Generation Workstation (SGW) 135 component. An SGW provides an application for viewing and modifying scenario data to the enterprise user responsible for defining and editing a scenario. In the preferred embodiment of the invention, this data is XML data and while it is possible to edit this data textually, such editing is error prone and not conducive to maintaining an enterprise-specific interpretation of the data. The workstation features a supportive user-interface that provides this interpretation and fully utilizes the graphical display capabilities of modern computer hardware including high density bit-mapped displays.

The workstation operates on data that conforms to one or more DIF 100 formats. Each format is editable by a workstation component that recognizes the format and tailors the available functions and features of the component according to the format. Because these formats are subject to change as the enterprise information model matures, the workstation components include the ability to evolve accordingly. The present invention includes the server component 115 as the built-in source for the latest workstation software that is delivered to the user in a manner similar to the delivery of scenario data. In the preferred embodiment of the present invention, the Java Web Start (a Sun Microsystems trademark) mechanism is employed to ensure that workstation software is the latest available to be compatible with the DIF formats in current use.

The SGW supports two kinds of editing: micro-editing where individual data elements can be created, modified or removed, as well as macro-editing where data sets are modified by applying large-scale transformations. For UOB data, examples of micro-editing include defining a new air base, changing the location of an existing base, or deleting a squadron of aircraft at a base. Some examples of macro-editing are the need to replace (“translate” or “map”) all allocations of B1 aircraft to any squadron and instead use B2 aircraft, or to ignore all squadrons that are composed of ATF aircraft, or to make sure that each base includes at least 50 XYZ500 items in its equipment inventory. Another example is to take two different data sets and merge them together to create a new data set that includes all non-conflicting elements from each data set.

The workstation components recognize and offer support for both kinds of editing and permit the user to save macro-edits as options to be applied to one or more datasets. The server component includes processing elements (engines) to apply the macro-edits to selected data sets within the server. Two distinct engines are identified in the present invention. One, the data translation/mapping engine 140, is responsible for creation/substitution/removal transformations and the other, the data difference and merge engine 145, provides the means to select data sets for comparison, determine the applicable differences among the data sets, disambiguate overlapping elements among the datasets, and produce a new “merged” data set.

The present invention is designed for use within an enterprise. Not all users within an enterprise will have equal authority to make changes to important information assets of the enterprise. The system of the present invention therefore defines an integral user management component 150 to control access to information and the ability to make changes to this information. Where the enterprise already has a well-defined structure for managing its set of users, the Scenario Generation User Manager can simply plug in to this structure to gain access to the collection of users. But the Scenario Generation framework maintains its own set of user attributes and roles to support controlled access to features and capabilities of the environment. Where there is no existing user management structure, the Scenario Generation framework provides basic features of defining users, deleting users, and managing their access rights and abilities.

Further included in the present invention is the Scenario Generation Workflow Engine 155. This engine is responsible for process definition, management and application. In the preferred embodiment of the present invention, existing standards and approaches to process specification and enactment are used to reduce the need to develop a process infrastructure from scratch. One candidate for such a standard is BPEL: Business Process Execution Language. Regardless of what technology is used, process support ensures that information gathering and editing is combined with adequate review and approval activities to insure enterprise information quality and correctness.

Multiple users 160 with varying roles and responsibilities need access to Scenario data. These data and their transformation must be subject to quality control as they are made ready for dissemination to applications. As data are modified as part of the Scenario preparation process, reviewers need to be notified that their input is needed, and their analysis and actions need to be communicated across the enterprise so that progress to final data readiness for Scenario Generation proceeds in a timely manner. The formal definition of enterprise workflow processes provides important enterprise artifacts that can be reviewed and refined by the enterprise. Once defined, these processes are enacted by the workflow engine which in turn communicates the intermediate state of these processes to interested users and other parts of the Scenario generation system.

Component and User Interactions

The two most important interactions relate to the movement of data into and out of the server. There are two main types of data movement: data that already exist in an understood format (e.g., SGSDIF, its extensions and related enterprise DIF formats) and data that need to be converted to an understood format. For the former, the server 115 provides a User Interface (UI) option to Import/Export Services 165 for the user to locate where data in an understood format is located (or is to be stored) and the data are transferred in SGSDIF XML 100 (or other enterprise DIF XML) from/to the user's selected location. For example, the user might elect to save an SGSDIF file to a temporary work area where it can be modified using the SGW 135.

For the latter type of movement, a data adaptor 130 must be used. In a preferred embodiment, the server includes a UI option to pick from a set of available adaptors. Where necessary connection parameters and authorization credentials can be supplied. Scenario data are then transferred by the adaptor to/from the server. In a mature enterprise employing the system and methods of the present invention, there can be unattended transfers of data between the server and data adaptors. If the adaptor is written to support a communications protocol 120 supported by the framework, web services can be invoked using the protocol and these communication events can occur based on business rules regarding when and how information sources should contact the server to refresh data available from the sources.

The present invention offers the ability for a user to update the version of the SGW 135 directly from the SGS. Such updates are required if the SGSDIF (or related enterprise DIF) specifications change, or when a new DIF is defined in the SGS Metadata catalog 125. The user can use the SGS and a UI element available on the server to get the latest version of the workstation. Alternatively, a UI element within the workstation itself can be used to determine when a new version of the software exists and to download it. In a preferred embodiment of the invention, a user preference feature of the workstation can be selected to determine automatically if a new version of the software exists and further exercise the option to download the new version.

The main component interactions for the workstation relate to loading and storing Scenario data. This can be done either by querying the server for available data sets, or by picking a location where one or more data sets exist as saved files or can be saved as such. The user then makes use of the workstation's UI to make changes to these datasets. In a preferred embodiment, the workstation presents opportunities to perform both micro- and macro-edits of scenario data. After micro-editing operations have been completed, modified data sets are saved. After macro-editing operations are completed, both modified data sets as well as data supporting application of the macro-edits can be saved. When the macro-edit transformation data is saved to the server 115, SGS UI elements permit the user to apply these data on server-resident data sets resulting in transformed data being sent to enterprise applications or saved as new versions of Scenario data on the server.

In a preferred embodiment, two kinds of large-scale transformations are provided: translation/mapping 140 and comparison/merging 145. For each case, UI elements are provided to make selections or otherwise set up the transformation and save this set up information for reuse. A companion set of UI elements enable the user to apply the transformations to data sets and to save or transmit the transformed data using the server and/or workstation.

The system and methods of the present invention include the ability to prevent a user from using an embodiment of the present invention unless that user has been authenticated 150. UI elements are provided within the server and workstation to provide authentication credentials (e.g. user name and password). If the embodiment is being used in an enterprise network context where users have already authenticated themselves, additional authentication can be tailored, such as might be necessary only when especially sensitive operations are being performed. For example, an already authenticated user may be challenged for additional credentials when the user wants to delete a Scenario data set.

Administrative Scenario generation users 160, provided they have supplied the proper authentication credentials, will also have access to additional UI elements to manage the population of users. These elements will permit the creation and deletion of users and the assignment of roles/privileges for these users. These roles and privileges are important to process management since certain steps may require users to be authenticated at a predetermined level to perform these steps and require notifications be made to users at various management levels when such steps have been performed by any user.

The system and methods of the current invention regarding workflow processing 155 include three main kinds of interaction: defining workflow processes, enacting workflow processes and monitoring workflow processes. The first workflow processing requires UI capabilities either as an integrated part of the workstation or via a separate extension of the server for a user to detail a formal process. In either case, access to a specific process representation capability is provided and storage facilities for defined processes are included in the SGS. In a preferred embodiment, the UI is tailored for the task of Scenario generation process definition rather than for general purpose process definition.

Once processes are defined, they can be initiated and monitored. Process enactment means that the process is passed to the workflow engine which is then responsible for controlling the workflow defined in the process. Typically, a user will initiate a process that includes a series of conditional process steps, possibly broken down into sub-processes. The Scenario generation framework is responsible for monitoring conditions affecting the process and noting when steps that require user actions are eligible for action or when such steps have been completed. When preconditions for a specific process step have been met, the framework must inform those users (using Messaging Services 170) who have authority and responsibility for that specific process step. If preconditions indicate that a particular framework component should now be executed (and no user interaction is required), the component may be executed by the workflow engine. When a step has been completed, the framework can then allow further steps in the process to take place. When no progress is made in a timely fashion, the framework can notify an administrative user who can examine the server's data regarding the process and take administrative action. When all steps in the defined process have been completed, notifications may be sent to users who are authorized to receive such notifications.

In a preferred embodiment of the current invention for Scenario Generation workflow processing, commercial off the shelf (COTS) software components may be applicable. COTS can be leveraged to provide a basic process description framework consistent with emerging industry standards. Specific SGS-related functionality will be added. A specialized process definition and editing component for Scenario Generation processes can boost the efficiency of enterprise users in completing process descriptions.

Capabilities

The core capability of the present invention is a unified view of data transfer between a collection of data sources which provide authoritative enterprise information and a family of enterprise applications or systems that need to be initialized in a uniform and coordinated manner based on the information. Solving this initialization problem is the fundamental purpose of the present invention.

The Scenario generation framework must necessarily support import of data from data sources and export of data to applications. Additionally, the present invention implements the point of view that data produced or used by enterprise applications may in time become authoritative data with respect to other application clients. The capability of importing data from applications is provided to meet this potential future need. Similarly, the system anticipates that information sources may need to be adjusted to match the needs of the enterprise.

In the military simulation and training enterprise, war fighters are given orders from real world command and control systems. Information in the orders can include UOB 105 data such as the location of targets, target attributes, enemy unit capabilities that surround these targets etc. In order for these orders to meet training objectives they may need to refer to specific locations and enemy capabilities that the real world system is not currently capable of generating. If the information source is wrapped with a data adaptor 130 that can process the addition of data to that information resource, the supporting data for generating orders that refer to the training targets, and assume enemy capabilities of the sort being trained for, can be arranged. The data adaptor responsible for importing data from this information resource to the server can then permit adjusted real world data to be obtained and used for simulation system initialization.

Supporting the import and export of scenario data, the present invention provides services to translate or map data so that substitutions at many levels within a specific Scenario data set can be made. Typically, mapping services are defined at the SGW 135 level but they are most often applied at the SGS level 140. The user has the option of executing a translation service and having the resulting data set saved to the server, saved to location of the user's choosing, or having the translated data set exported to an application via a data adaptor.

Because in many cases Scenario data sets will be realized as XML files, and therefore can be edited by tools outside of the framework, it is important that verification of data be done when data is transferred into the server. Even when data is transferred into the server by an integrated data adaptor, it may be possible that errors in data set format may be present. To mitigate these errors all movements of data are checked by standard data verification services 175. Verification needs to be done both for data in the basic internal format (SGSDIF) as well as any other enterprise information contexts that are supported by their own DIF specification. Without such verification being performed whenever potential changes are introduced, it is possible that the wrong information could be passed on to consuming applications leading to application failure and subsequent harm to the enterprise and its activities. In a preferred embodiment, any failure to verify data results in a message or display to the user, highlighting the exact location within the dataset that is at fault.

Messaging services 170 are integral to workflow processing and coordination of distributed scenario generation activities among multiple users. In a preferred embodiment, these messaging services are layered on top of the enterprise's preferred communication channels (organization email, instant messaging capability, etc.). Information must identify exceptional events that need corrective action as well as routine status messaging regarding workflow through the Scenario generation system. Messages describing work items for enterprise users along with reporting information for enterprise managers are supplied.

Across an enterprise, it is likely that the means by which information system entities are able to share and distribute their own information are many and varied. To support this variability, the present invention includes a number of communication channels and methods. These methods 120 include flat file data imports and exports with supported formats including XML (using SGSDIF and related schemas) and CSV (Character-Separated Value) files, JDBC™ (Java™ Data Base Connectivity), JMS (Java™ Messaging Services), FTP (File Transfer Protocol), HTTP (HyperText Transfer Protocol), and SOAP (Simple Object Access Protocol).

Also across an enterprise, there will be several distinct classes of users 160, each with their own expectations of the services and capabilities offered by the framework. Each of these user classes is best served by a User Interface specialized to its specific role and its expected set of Scenario Generation activities. For example, in the military training and simulation domain, three important user classes have been identified: the overall Enterprise administrator or supervisor; event and area controllers responsible for the assembly of data and coordination of systems for a specific training exercise; and scenario editors who may be responsible for specific enterprise applications/systems, or for preparation of all data in a specific category (e.g. all data within a specific geographic location, all enemy data, all radar system data). The administrator has responsibility over all users and may need to support multiple events. Typically, the event coordinator is responsible for overall data gathering and preparation, and reports to the supervisor. Each scenario editor reports to the event coordinator and may need to share and coordinate data where there is overlap.

Each of these user classes needs access to different functions and capabilities within the framework. The UI presented to the user is best adapted to the class of user. In a preferred embodiment, both the look and feel of the UI as well as the options and features of the UI are adjusted for the user. For example, only the administrator user has access to user management 150 functionality. Only administrators and event controllers are able to define, modify and control the execution of workflow processes 155. Scenario editor users have access to the workstation component and selective access to data sets available on the server. In this example, UI elements related to user management and process definition are never shown to scenario editor users. Process notifications that affect individual users and the list of actionable process steps for a user are always available.

Each enterprise needs to support multiple information contexts 105, 110. Each context can be encapsulated by one or more Data Interchange Formats (DIFs) where the core context is handled by the SGSDIF initially defined for the enterprise. The military training and simulation domain features a core context for Unit Order of Battle (UOB) data and the SGSDIF for this domain is designed to present and organize information for this context. But this context is one of many. Others include terrain data, parametric data, and cultural features data.

The present invention provides resources to define DIF definitions for additional contexts. In some cases, a new context will naturally extend the basic context defined by SGSDIF. Other contexts will need to deal with completely different kinds of information and the DIF for this context will be defined to serve the needs of the enterprise independently of the basic SGSDIF.

The capabilities of the Scenario Generation Server will naturally apply to data sets appropriate for multiple contexts. But the functions and features of the Scenario Generation Workstation are best based on the kind of information appropriate to the context and further support diverse editing paradigms. The present invention includes facilities to support automatic adaptation of the workstation, based on the DIF definition for the context, to add support for new information items and to select editing and display features supportive of making changes to data bound to the context.

### DETAILED DESCRIPTION—PREFERRED EMBODIMENT

The preferred design approach for implementation of the components, interactions, and capabilities described above with respect to an embodiment of the present invention can be best understood with some notional screen snapshots and diagrams taken from an instance implementation of the invention for a specific enterprise. The enterprise chosen is the one used elsewhere in this document: the military training and simulation enterprise.

Four main areas of emphasis are included in this discussion: an SGSDIF specification and sample document; an embodiment of the Scenario Generation Server and access to subordinate functions available through the server (window snapshots); an embodiment of the Scenario Generation Workstation and both micro-edit and macro-edit features available through the workstation and server (window snapshots); and consideration of the preferred embodiment of workflow support. FIG. 1 can be consulted to recall how these various features relate to one another. The next section of this document will describe enterprise user actions that indicate how to operate the invention within the preferred embodiment.

The figures are meant to highlight important benefits of the invention and a preferred distribution of crucial elements of the invention within the preferred embodiment between workstation client (135 in FIG. 1) and scenario generation server (115 in FIG. 1).

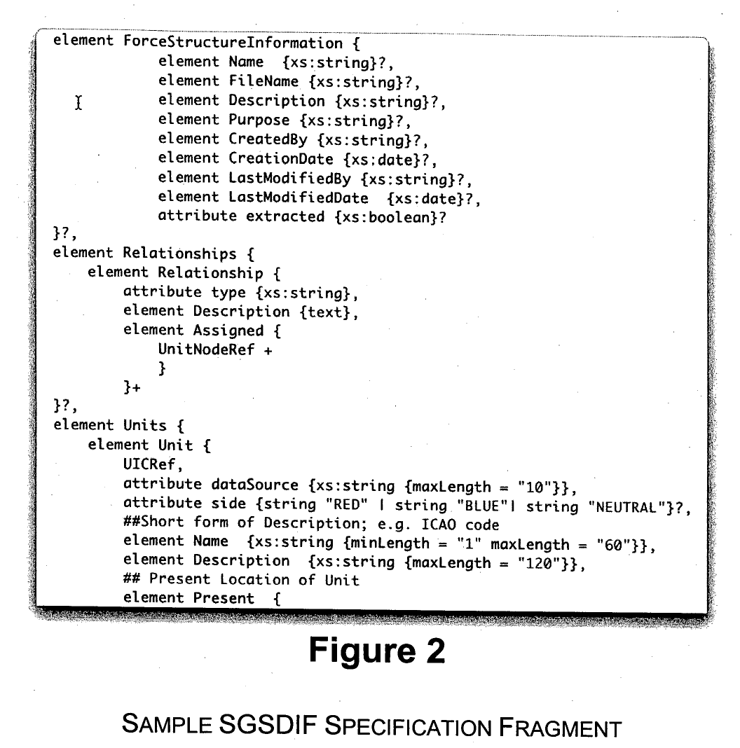

FIG. 2 depicts a sample fragment of a formal SGSDIF specification for Unit Order of Battle (UOB) data pertinent to the training and simulation domain. The syntax employed in this specification is known as RELAX NG and is a less verbose alternative to the more dense specification format provided by the XML Schema Definition (XSD) language. In the preferred embodiment, all enterprise information contexts would have a corresponding formal description in XSD or equivalent syntax. There are several commercial tool offerings that support creating such specifications.

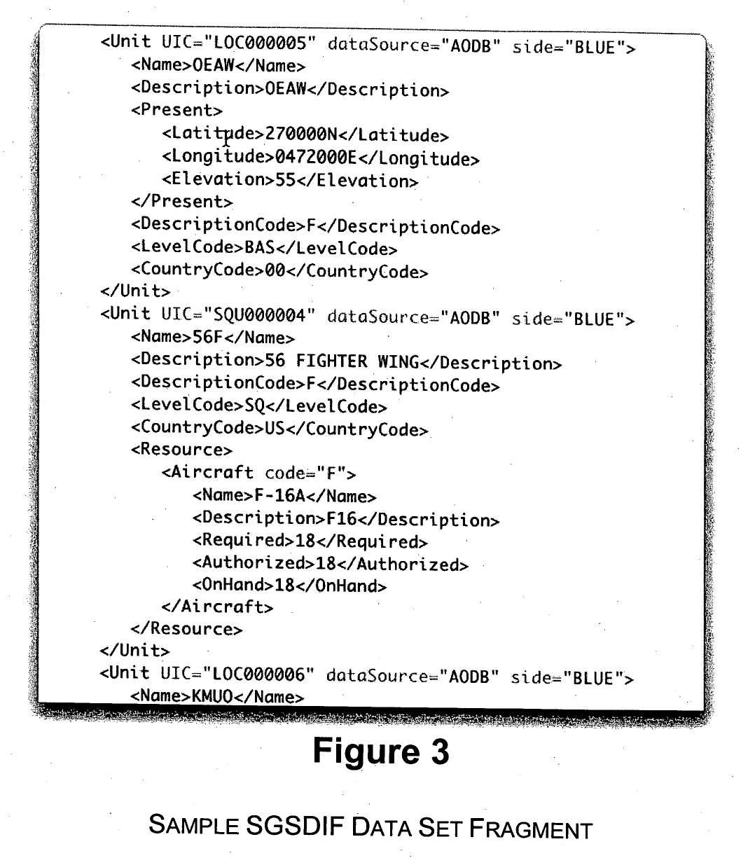

Once a DIF specification is defined for an enterprise information context (105 and 110 in FIG. 1), it is possible to create data sets that conform to the specification. For XSD specifications, conforming data is realized by XML files that can be verified against the schema definition. FIG. 3 shows a sample SGSDIF data set fragment that conforms to the SGSDIF specification for UOB data illustrated in FIG. 2. Commercial technology exists to help a human user manually to produce conforming data sets but such manual processes are insufficient for the needs of enterprise application integration.

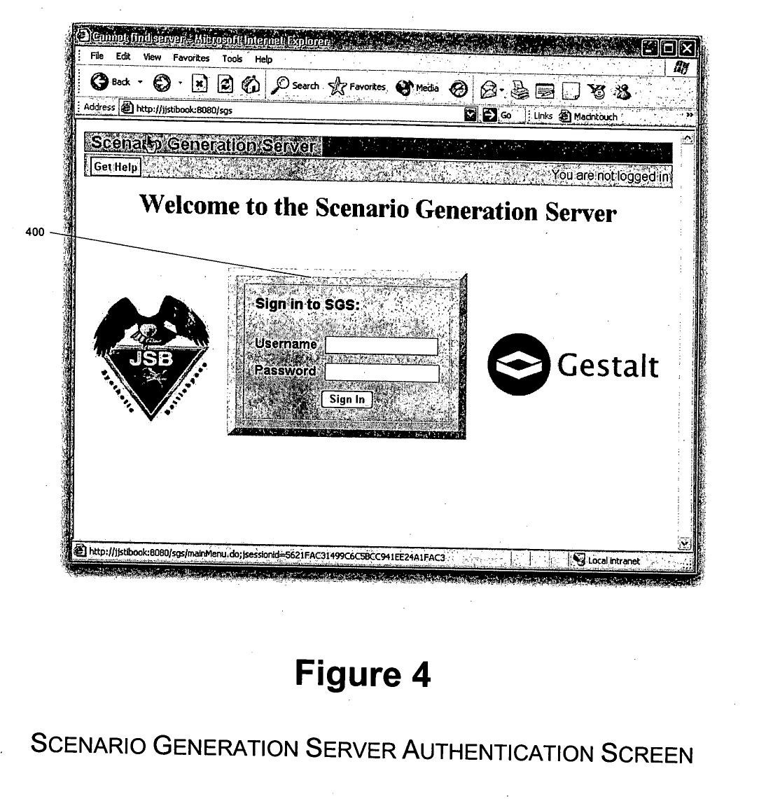

Data already exist within the enterprise that need to be represented using the DIF specification. In a preferred embodiment, data adaptors (130 in FIG. 1) are provided that transform data from enterprise information sources and place it within a server environment. Access to the server is provided by a web application hosted on any number of commercially available application platforms. FIG. 4 shows an example user login screen for an example Scenario Generation Server. The user must supply enterprise-recognized credentials 400 to access the features provided by the server—in the example a user name and password is required to sign in.

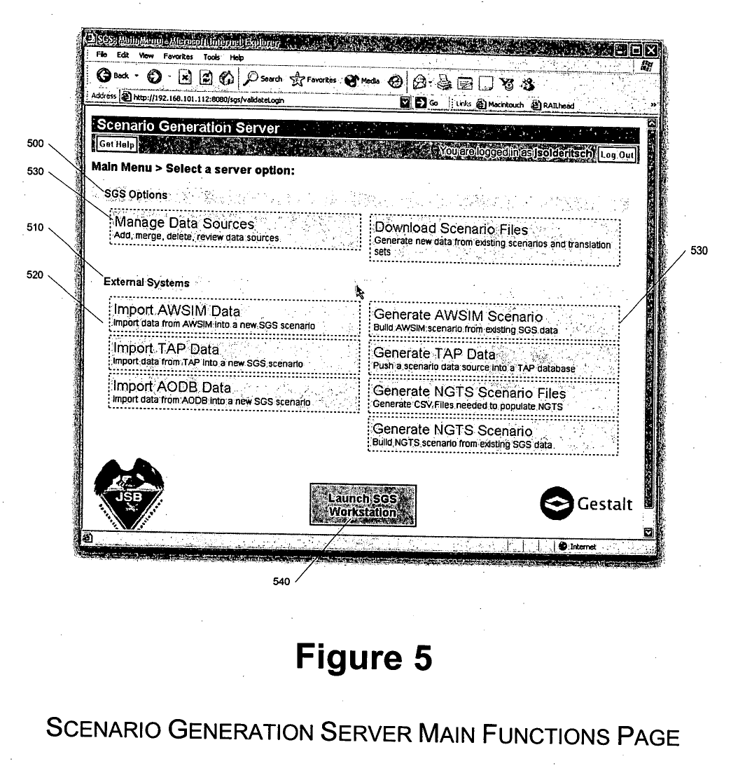

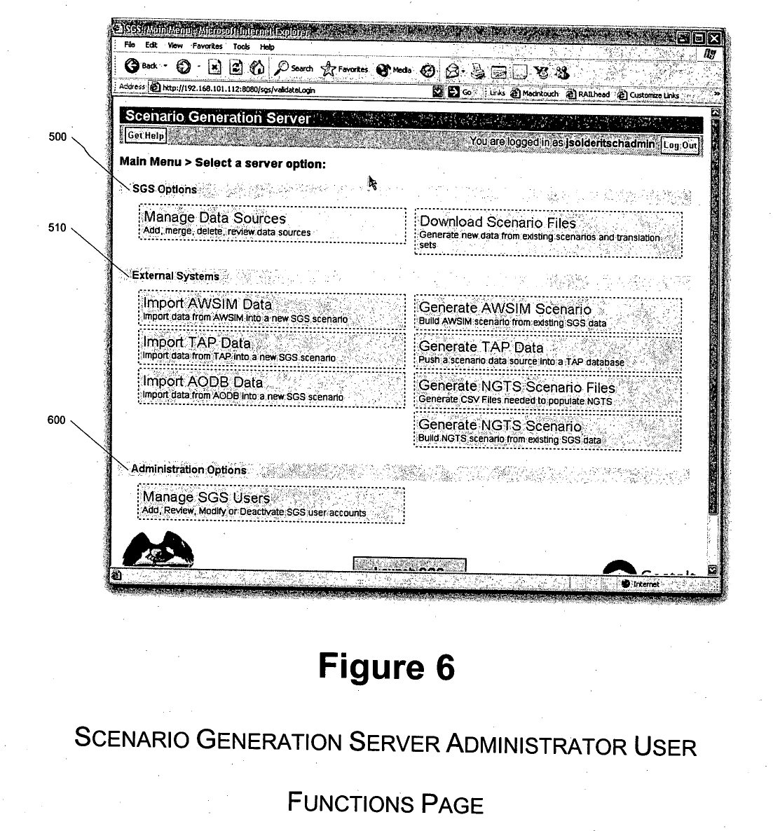

After an enterprise user supplies the proper credentials, a main functions screen such as that shown in FIG. 5 will appear. In the preferred embodiment of the present invention, these functions will be grouped into related categories (such as SGS Options 500 and External Systems 510 as shown in FIG. 5) and the set of offered functions will be specialized according to the role that the user is known to possess and the associated access rights. For example, FIG. 6 shows a modified main screen that adds access to a group of Administration Options 600 including the ability to manage the collection of Scenario Generation users.

The External Systems area of FIGS. 5 and 6 show some data adaptors that can be invoked by the user. Column 520 indicates access to functions to extract SGSDIF information from data sources and save it to the server. Column 530 indicates access to functions to move data from the server and generate initialization data for various applications of importance to the military training and simulation enterprise. To execute any of these functions, the enterprise user will supply connection information to enable the data adaptor to access the desired information source or application.

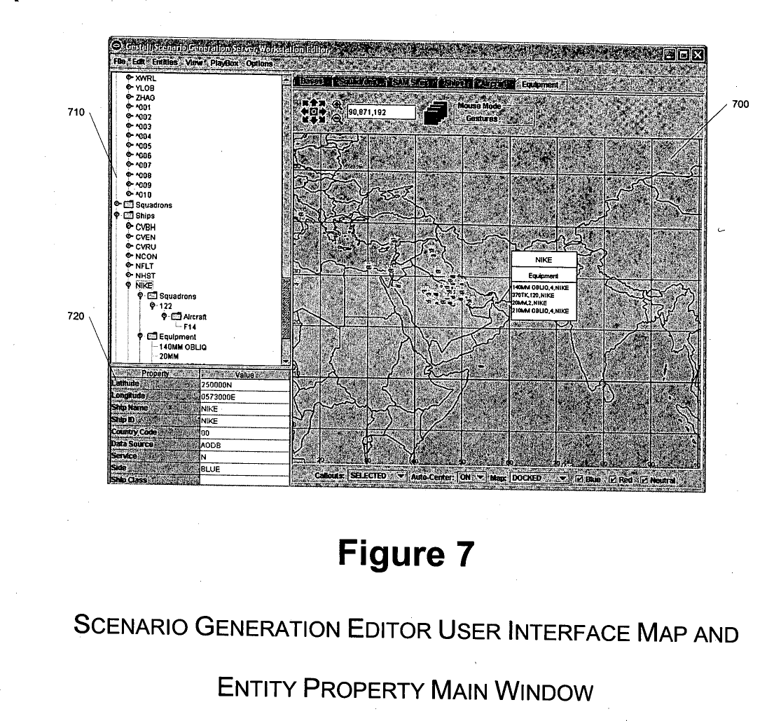

Referring again to FIG. 5, the Launch SGS Workstation 540 option is shown. Clicking this option will cause the server to check if the user's installed version of the workstation software is up-to-date or if there is no current software installed, in the preferred embodiment the latest version is installed automatically. Further in the preferred embodiment, Java Web Start (a Sun Microsystems trademark) is used to accomplish this workstation version verification and software updating. Optionally, the downloaded software can be executed automatically. FIG. 7 shows the Scenario Editor portion of the workstation in operation. For UOB data, it is convenient for the enterprise user to see a map 700 where geographical locations of units are depicted. To augment the map view, the preferred embodiment of the current invention provides additional views. FIG. 7 shows two additional views: a tree view 710 that can be expanded or collapsed to show or hide subordinate detail, and a properties view 720 through which the user can make changes to a particular information element. This workstation display shows how individual data items can be selected and changed, thereby accomplishing micro-edits of enterprise data.

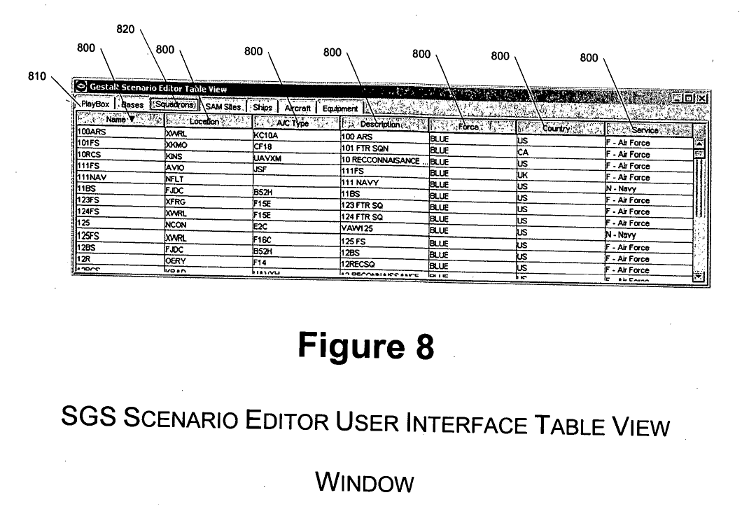

In the preferred embodiment, the map view 700 can be detached from the main window to stand on its own, and the map view 700 can also be resized to meet the user's preferred way of interacting with the editor. In addition, FIG. 8 shows yet another example of UOB data, in a spreadsheet-like tabular display. Such a view provides a convenient summarization of the data defined in the data set being edited and allows sorting of the information elements by clicking on any of the column headers 800. The data shown in the tabular display can also be specialized to a particular kind of entity—the entity to focus on can be changed by clicking the named tab shown above the column headers 810. FIG. 8 shows a display of data focused on Squadron data 820.

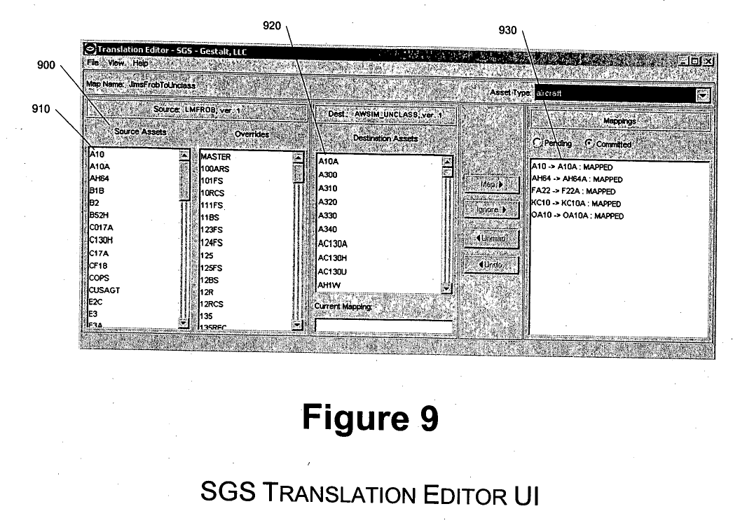

FIGS. 7 and 8 both show UI capabilities related to details of the information being edited. FIG. 9 shows the SGS Translation Editor UI from which macro edits can be specified. In the example shown in FIG. 9, aircraft choices 900 for the training and simulation domain are being considered. The main idea illustrated by the figure is that one choice representing a UOB entity (e.g. A10) 910 might need to be mapped/translated into another (e.g. A10A) 920 in order for successful Scenario generation to take place for at least one of the applications that need to be initialized from the server. In the preferred embodiment, the translation editor component of the workstation enables the definition of these translations 930 that are themselves saved to the server. From the server, the translations can be applied to any data set and the transformed data set can either be saved on the server or passed on to a data adaptor to complete software generation.

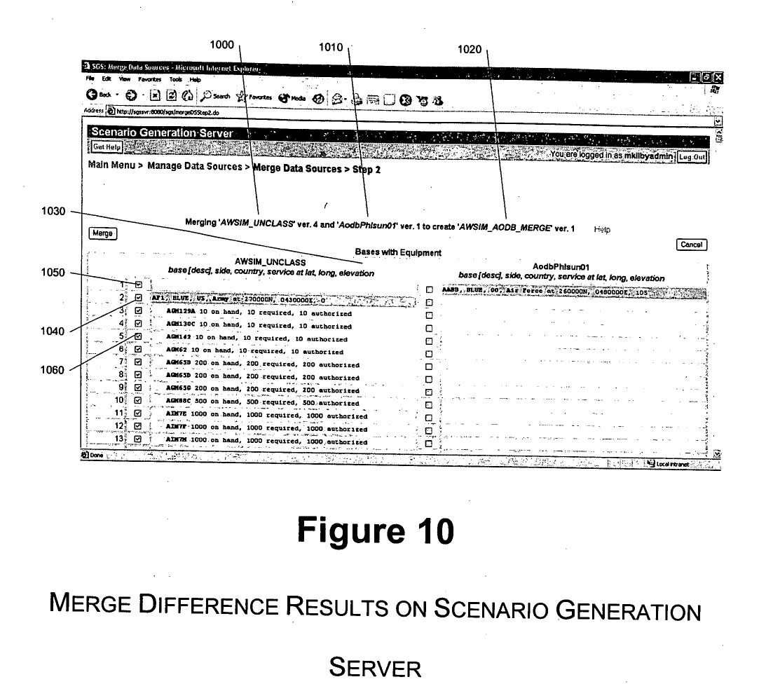

FIG. 10 illustrates another kind of macro-editing: the ability to compare and ultimately to merge two datasets—specifically, in the example shown, dataset 1000 and dataset 1010 are compared and merged to produce 1020. The figure shows this edit function being provided at the server level. In the embodiment shown in FIG. 10, it is a feature reached from the Manage Data Sources 530 option shown in FIG. 5. An alternate embodiment of the present invention could provide access to this feature as a workstation function. After the enterprise user has selected two data sets to compare, a tabular list of differences 1030 is shown in the main display with the user able to select which variation is desired by clicking in the appropriate box 1040. When one data source does not contain a comparable item, the display is left blank. Clicking a box next to a blank item 1050 indicates that the item is not to be included in the data set resulting from the merge. Subordinate items 1060 can be selected independently from the enclosing item. For the UOB display shown in FIG. 10, equipment items 1060 at a base 1040 are shown indented beneath the base.

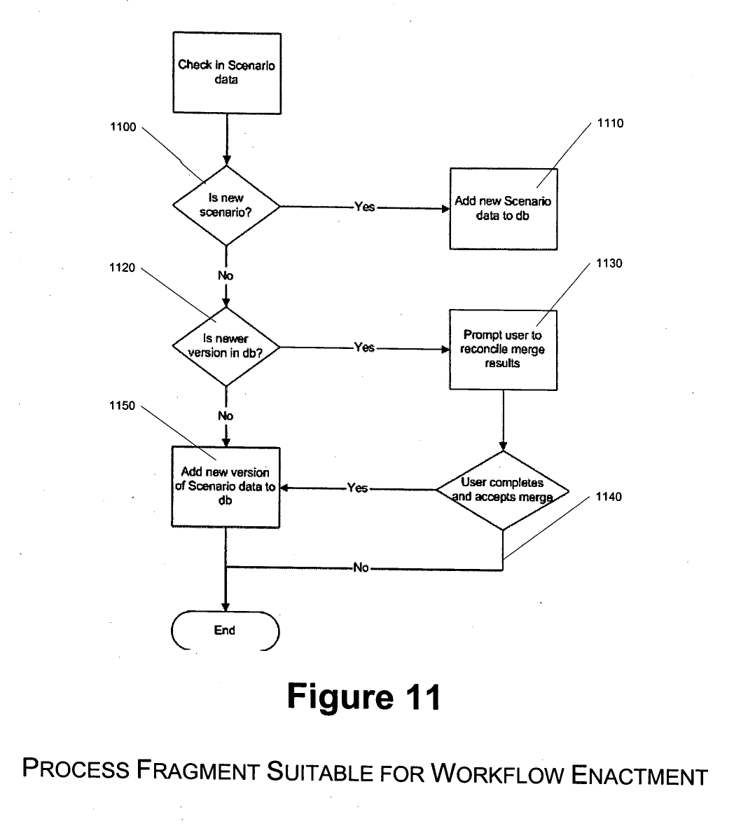

FIG. 11 shows a process fragment related to the workflow of Scenario generation. Rather than allowing users to store new versions of a Scenario data set to the server indiscriminately, this process checks 1100 whether an existing version of the scenario already exists. If the scenario is brand new, the user is able to store it on the server 1110. If an older version does exist 1120, the user is required to conduct a merge between the version selected for storage and the latest existing version and make sure that the new version has desired characteristics in comparison with the existing version 1130. For example, if there are no changes, or if the user realizes the wrong changes have been made, storage of the new version can be canceled 1140. If the user accepts the results of the merge as being consistent with the intended changes, the new merged version is added to the server 1150.

Any specific embodiment of workflow process support will depend on which process definition framework the enterprise selects for inclusion in the framework. As persons of ordinary skill will recognize, a preferred process support framework and an embodiment of the invention with minimal process support is attainable. A preferred embodiment would include a robust and inclusive workflow process capability built on process description and representation standards.

The ultimate purpose of the invention is effectively to enable an enterprise to coordinate and manage information transfer between various information sources of interest to the enterprise and applications/systems within the enterprise that need to be initialized with data so that they can begin execution based on the data. Each application receives data in a form that it can import and process, but because the data is based on a common intermediate form whose preparation has been managed by the enterprise, all applications will share a unified starting point.

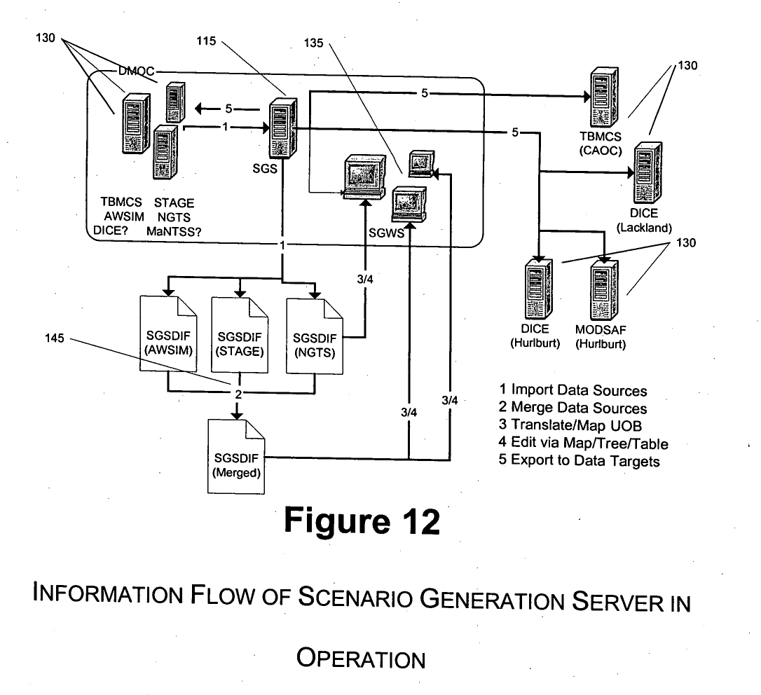

FIG. 12 provides a high level overview of the overall process by which the invention is used to provide Scenario generation for the military training and simulation enterprise. Primary information sources 130 are identified. In the preferred embodiment, each of these sources is equipped with a data adaptor through which SGSDIF (or a related DIF) compliant data can be extracted and this data adaptor is integrated into the SGS interface 115. In some cases, information sources may be physically disconnected from the central server (e.g. for security reasons), and then the data adaptor must be executed manually and the resulting SGSDIF data manually inserted into the server. In the preferred embodiment, the server includes both options for importing data.

From the server 115, data from each of the primary information sources can be used in a comparison and merge task 145 to create a single data set 100 used in subsequent editing activities. In the preferred embodiment, the user can operate UI elements within the server to select the data sources to merge, see and resolve conflicting elements from each of the sources, and create a new merged data set that is then stored on the server 115. Alternatively, the individual data sets can first be edited separately using the features and functions of the workstation 135 and then after edited versions of the data sets are saved on the server 115, these can be merged to form a merged data set.

The workstation 135 provides both kinds of editing capabilities: micro-editing of individual data set elements or macro-editing by means of the creation of translation specifications that are to be applied to an entire data set. In the preferred embodiment of the invention a single workstation application provides both kinds of editing capabilities.

Once editing operations have been completed and reviewed, the modified data sets are ready for export to target applications 130. These target applications may be distributed geographically across the enterprise's network. In the preferred embodiment, the server 115 includes UI components through which connections to each application can be made, and from which data can be passed to a data adaptor that can convert SGSDIF data into a form accessible by the application. For applications disconnected from the network, the server 115 can be used to save file copies of the SGSDIF data that can be manually saved and inserted into a data adaptor running on the host machine of the application.

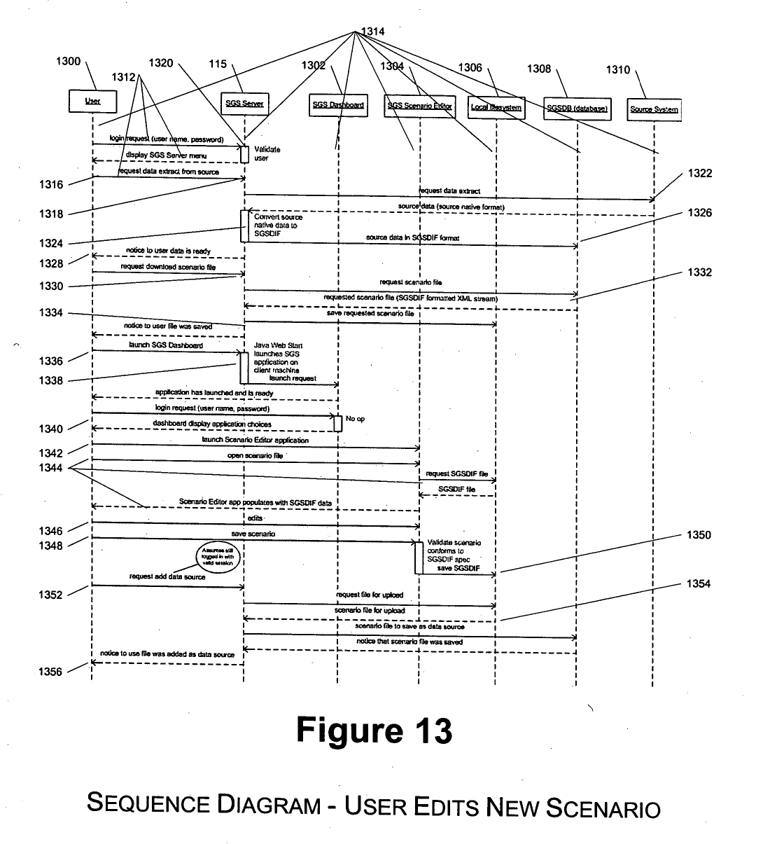

FIG. 13 breaks down the high level view of the operational activities shown in FIG. 12 and sequentially follows the steps that an enterprise Scenario editor might follow in obtaining data from an external source, editing it locally, and saving the edited result to the server. The user 1300 and the components the user interacts with are shown as boxes in the top part of the figure. These components include the server 115, the top-level interface to the workstation identified as the SGS Dashboard 1302, the SGS Scenario Editor 1304 component of the workstation, the user's local file system 1306, the underlying database 1308 of the Scenario Generation Server, and the Source System 1310 from which SGSDIF data is originally obtained through a data adaptor (not shown).

The flow of information is represented in FIG. 13. User and system component interaction events occur over time and these are represented as directional arrows drawn 1312 horizontally across the figure. The passage of time and/or sequence is indicated by the vertical position of these horizontal event arrows—the first arrow is the first event, the next arrow below is the next event, etc. Note however that the vertical distance between these event lines should not be interpreted as the scaled passage of time—infer only that the events occur consecutively in the order shown in the diagram. The vertical lines 1314 allow the events to be tied to the originator of the event and the corresponding processing component of the event. The base point of an arrow 1316 indicates the originator and the termination point of an arrow 1318 indicates the specific processing component. A vertically oriented box along a vertical line 1320 indicates that processing takes place within the component to produce a subsequent event.

Note that this is not the only way that a sequential set of activities leading to the creation of an edited data SGS data set can be arranged. But the sequence of events shown portrays the effectiveness of the invention in aiding the completion of activities leading to Scenario generation.

The first event 1312 shown in FIG. 13 is the user 1300 logging in to the server. In the preferred embodiment, the user uses a Uniform Resource Locator (URL) entered into a web browser to begin this activity. The server validates 1320 the user and displays the main set of server options 1312 (second horizontal line) in the user's web browser. The user 1300 picks one of the available data sources and uses the server to request a data extract from the source 1312 (third horizontal line). FIG. 13 shows the server processing a data request from the source system and the source native format of this data being returned 1322 to the server from the source where it is converted to SGSDIF 1324. In the preferred embodiment, some data source adaptors would include conversion of source data to SGSDIF data by an extension to the source system so that SGSDIF comes directly from the source. Other data source adaptors would provide unprocessed source data that the server will need to convert.

The next event is the saving 1326 of the SGSDIF format of the source data to the SGS data base (SGSDB) 1308. The server will notify the user when the data is ready (the extract process has completed) 1328, at this point the user can request a download 1330 of the data from the server. The server locates the corresponding data set in the SGSDB and a SGSDIF XML data stream is sent 1332 to the server. Next, the user is notified that the SGSDIF data is ready for the user to receive and the user picks a location on the user's local file system where the SGSDIF can be saved 1334. In the preferred embodiment, the user can query the SGSDB directly from the workstation for available data sources (the user may need to login from the workstation to gain access to the data base) or alternatively can use the server as an intermediary as shown in the example described.

Once the user is notified that the file save is complete, the user picks the Launch SGS Workstation option 1336 from the server. In the preferred embodiment, the Java Web Start (a Sun Microsystems trademark) framework 1338 verifies whether the user has the latest workstation software available and updates it (or downloads it initially if the software is not present). When the latest workstation software is installed, it is executed and the user sees the SGS Dashboard. In the preferred embodiment, both scenario editing functions and translation editing functions are selectable from the dashboard. FIG. 13 is focused on editing activities.

After the dashboard is displayed, users can select how they want to work: with a locally available file or data sets located on the server. FIG. 13 shows an additional login activity 1340 that is only necessary if the user wants to access data sets on the server. To edit a local file, no additional login activity is required. From the dashboard the user elects to launch the Scenario Editor application 1342. From the UI of the editor, the user chooses 1344 to open a Scenario File locally. The UI of the editor allows the user to pick a file to edit and this file is read and the contents of the file are used to display SGSDIF elements with the main display of the editor 1344. In the preferred embodiment, verification of the SGSDIF file is done according to the SGSDIF schema specification and error messages are displayed to the user as appropriate.

Once the SGSDIF data set has been loaded in the editor, various editing actions are performed. These are not shown in FIG. 13—the line labeled edits 1346 indicates that a multitude of user actions will take place in order to complete the editing task. When these activities have been completed, the user selects the save scenario option 1348 of the editor and this results in a modified SGSDIF file being saved to the user's local file system 1350. Again, in the preferred embodiment, saving an SGSDIF file locally is just one option for the user; alternatively, the user can save the modified dataset as SGSDIF data to the server. The server may incorporate a workflow process to insure that the user is authorized to save the data set.

If the user has saved the SGSDIF data to a local file, the server UI is used to request that a new data source be uploaded 1352 to the server. The user's login credentials are checked as necessary. The server UI allows the user to select which file contains the SGSDIF data to be uploaded and the server then completes the upload 1354. In the preferred embodiment, the server also performs SGSDIF data verification in conjunction with the upload process and the user is alerted appropriately 1356. In uploading a Scenario file, a brand new data source name can be picked or the file can be used to define a new version of an existing data source. Workflow processes may be in operation that monitor the creation of a new version.

The user is notified concerning the success or failure of the upload. Although not shown in FIG. 13, an exemplary next step for the user is to export the edited file to one or more enterprise applications. Access to application data adaptors is also provided in the SGS UI.

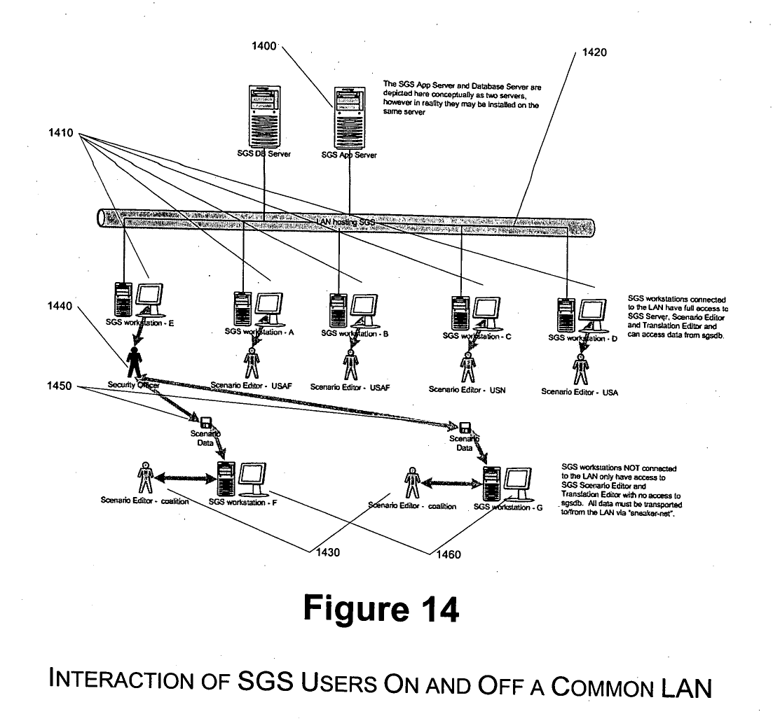

FIG. 14 depicts two styles of interaction with the SGS framework in the present invention. In the preferred embodiment, users operating the UI of both server 1400 and workstations 1410 are connected to a single enterprise LAN (Local Area Network) 1420 that connects all framework components together. For the military simulation and training enterprise, some parties (e.g. non U.S. coalition partners) 1430 may necessarily be disconnected from the main SGS network for security reasons. But these parties may still have Scenario editing responsibilities. The figure shows an enterprise authority, for example, the Security Officer 1440 using the LAN to get Scenario data 1450 which is analyzed and perhaps filtered before being distributed to the disconnected parties. Once these parties receive and process the data on their disconnected workstations 1460, the modified SGSDIF data is transferred back to the enterprise authority who after review, enters the data via the LAN.

The need to support both connected and disconnected users is a vital operational requirement for enterprise scenario generation and is supported by the invention. In addition to disconnected users, the preferred embodiment also includes support for disconnected information sources and application data consumers. Data adaptors will need to be executable from the server directly when the sources and consumers are available on the enterprise network. Information source adaptors will need to be executable manually to support disconnected data sources with the generated source data manually added to the server. Scenario data needs to be exported manually from the server in SGSDIF files and then these files are manually provided as input to an application data adaptor running in stand-alone fashion.

While this invention has been particularly described and illustrated with reference to particular embodiments thereof, it will be understood by those skilled in the art that changes in the above description or illustrations may be made with respect to form or detail without departing from the spirit or scope of the invention.

We claim:

1. A system for generating scenario data to initialize a plurality of applications operating over a distributed network, said system comprising:
a scenario generation server;
a scenario generation workstation connected to said scenario generation server;
a scenario generation data interchange format;
a scenario generation metadata catalog; and
a first data adaptor.

2. The system for generating scenario data of claim 1, further comprising a framework for construction of a second data adaptor.

3. The system for generating scenario data of claim 2, wherein said first data adaptor conforms with said framework.

4. The system for generating scenario data of claim 1, further comprising a scenario data translator.

5. The system for generating scenario data of claim 4, further comprising:
a scenario data difference analyzer; and
a scenario data merger.

6. The system for generating scenario data of claim 1, further comprising a scenario generation user manager.

7. The system for generating scenario data of claim 1, further comprising:
a workflow process definition; and
a workflow monitor.

8. The system for generating scenario data of claim 1, further comprising a data translation editor.

9. The system for generating scenario data of claim 1, further comprising a scenario data editor.

10. A method for generating scenario data to initialize a collection of applications comprising the following steps:
identifying at least one information source;
obtaining scenario data from said identified source in an intermediate data format;
saving said obtained scenario data;
modifying said obtained data and saving said modified data in said intermediate data format;
defining data translation specifications;
saving said data translation specifications;
selecting a plurality of scenario data sets in said intermediate data format and examining the differences between each of said plurality of scenario data sets;
merging said plurality of scenario data sets to create a merged scenario data set;
saving said merged scenario data set;
translating one of said plurality of scenario data sets;
saving said translated data set;
identifying a first one of a plurality of applications to be initialized from said scenario data; and
exporting scenario data to said first application in said intermediate format.

11. The method for generating scenario data of claim 10, further comprising monitoring each of said steps.

12. The method for generating scenario data of claim 11, further comprising controlling each of said steps from a single location.

13. The method for generating scenario data of claim 11, further comprising the step of defining a workflow process, wherein said monitoring and controlling complies with said defined workflow process.

14. The method for generating scenario data of claim 13, wherein said workflow process comprises a plurality of workflow steps, further comprising the step of defining each of said plurality of workflow steps.

15. The method for generating scenario data of claim 10, wherein said intermediate data format comprises extensible scenario generation data interchange format.

16. The method for generating scenario data of claim 10, wherein said information source comprises said a second one of said plurality of applications.

17. The method for generating scenario data of claim 10, further comprising the step of delivering said modified data to a workstation.

18. A system for initializing a plurality of connected applications operating in a distributed network, comprising:
a server;
a workstation connected to said server;
a data source;
a data interchange format;
a metadata catalog; and
a data adaptor.

19. The system of claim 18, wherein said data source comprises one of said connected applications.

20. The system of claim 18, wherein said data interchange format further comprises extensible scenario generation data interchange format.
